(19) United States
(12) Patent Application Publication
(10) Pub. No.: US 2025/0289547 A1
(43) Pub. Date: Sep. 18, 2025

(54) METHOD FOR OPERATING A TRACTION DEVICE COMPRISING A KITE FOR A FLOATING VESSEL

(71) Applicant: BEYOND THE SEA, La Teste de Buch (FR)

(72) Inventors: Yves Parlier, Arcachon (FR); Armand Torre, Leucate (FR)

(73) Assignee: BEYOND THE SEA, La Teste de Buch (FR)

(21) Appl. No.: 18/862,284

(22) PCT Filed: May 5, 2023
(86) PCT No.: PCT/EP2023/061932

§ 371 Date: Nov. 1, 2024

(30) Foreign Application Priority Data
May 5, 2022 (FR) FR2204268

(51) Int. Cl. B63H 9/072; B60K 16/00; B62B 15/00

(52) U.S. Cl. CPC B63H 9/072; B60K 16/00; B62B 15/002; B60K 2016/006; B63B 2209/20

(57) ABSTRACT

The method is for operating a traction device (3) of a floating vessel (1) that includes a kite (4) having a wing (5) provided with a leading edge (6), a flying line, at least one front line equipped with a clutch, and rear lines, the method includes making the wing (5) gain altitude, holding it only by the flying line, the front and rear lines remaining slack; subsequently, once an altitude has been reached, locking the at least one front line, by activating the clutch, enabling the at least one front line to be mechanically connected to the floating vessel (1); and releasing the flying line and keeping it slack.

### TECHNICAL FIELD OF THE INVENTION

The invention relates to a method for operating a pulling device. The invention also relates to a pulling device comprising elements for implementing such an operating method. The invention also relates to a floating vessel or a land vehicle comprising such a pulling device. The invention lastly relates to a computer program product for implementing such an operating method. The invention also relates to a data recording medium for implementing such an operating method. The invention also relates to a signal of a data medium for implementing such an operating method. The invention also relates to the use of a clutch during such an operating method.

### BACKGROUND ART

A kite for pulling of a floating vessel, such as a boat or a ship, is difficult to control during its launch from a deck of the floating vessel, during its retrieval on the deck, but also in flight.

Therefore, there are significant risks of seeing the kite become damaged at sea or through contact with the floating vessel or the ground during maneuvers. The conventional launching of this type of kite requires the complete unwinding of the lines intended to mechanically connect said kite to the floating vessel. This is possible on land but much more difficult at sea. One solution consists in allowing the kite to drift at the surface of the water and getting it to take off once the lines have been unwound. Another solution consists in using a specific vessel for getting it to take off in the wind and, a fortiori, for retrieving it. Such solutions are not satisfactory.

### SUMMARY OF THE INVENTION

The aim of the invention is to provide a method for operating a kite-based pulling device that remedies the drawbacks above. In particular, the invention makes it possible to automate the launching of a kite, its flight for pulling a floating vessel or a rolling and/or sliding land vehicle, and its retrieval.

To achieve this objective, the invention relates to a method for operating a pulling device of a floating vessel or of a rolling and/or sliding land vehicle, comprising a kite including:
a sail provided with a leading edge,
a flying line,
at least one front line equipped with a clutch, and
rear lines,

the method comprising the following steps:
a step of making the sail gain altitude, holding it only by the flying line, the front and rear lines remaining slack, followed, once an altitude has been reached, notably once a target altitude has been reached, by
a step of locking the at least one front line by activation of the clutch making it possible to mechanically connect the at least one front line to the floating vessel or to the rolling and/or sliding land vehicle, and a step of releasing the flying line and keeping it slack.

The method may comprise, simultaneously with or after the locking step, a step of tensioning the rear lines so as to use them to control the sail.

The method may comprise a prior step of inflating the leading edge of the sail, notably a step of inflating the sail by turning the sail into the wind, prior to the step of gaining altitude.

The step of gaining altitude may comprise a step of hoisting the sail along a mast of the floating vessel or of the rolling and/or sliding land vehicle.

The method may comprise a step of automatically orienting the sail with respect to the wind, notably by way of a boom articulated with respect to such a mast.

The step of gaining altitude may comprise a step of freeing the sail with respect to such a mast, then a step of making the sail freed from such a mast gain altitude.

The locking step, in particular the locking step, the tensioning step and the step of releasing and keeping slack, may be followed by a control step through control of the rear lines in order to control the sail in a flight mode of the sail, notably by way of at least one geared motor of a control device.

Subsequent to the control step, the following may be carried out:
a step of tensioning the flying line, and
a step of releasing the front and rear lines and keeping them slack, notably by winding in the flying line and/or unwinding the front and rear lines.

The flying line may be wound in so as to bring the sail back onto the floating vessel or onto the rolling and/or sliding land vehicle.

The invention also relates to a pulling device of a floating vessel or of a rolling and/or sliding land vehicle, comprising a set of actuators, notably of the geared motor and/or clutch type, the device comprising hardware and/or software elements implementing the method as defined above, notably hardware and/or software elements designed to implement the method as defined above, and/or the device comprising means for implementing the method as defined above.

The invention also relates to a floating vessel or a rolling and/or sliding land vehicle comprising a pulling device as defined above.

The invention also relates to a computer program product comprising program code instructions recorded on a computer-readable medium for implementing the steps of the method as defined above when said program is run on a computer, or to a computer program product that is downloadable from a communication network and/or recorded on a data medium that is readable by a computer and/or executable by a computer, the program product comprising instructions that, when the program is executed by the computer, lead the latter to implement the method as defined above.

The invention also relates to a computer-readable data recording medium on which a computer program comprising program code instructions for implementing the method as defined above is recorded, or to a computer-readable recording medium comprising instructions that, when they are executed by a computer, lead the latter to implement the method as defined above.

The invention also relates to a signal of a data medium, carrying the computer program product as defined above.

The invention also relates to the use of a clutch of the type forming a braided sleeve surrounding a line for holding a sail of a kite for pulling of a vessel or of a land vehicle, notably for holding a sail of a kite for pulling of a vessel or of a land vehicle in the method as defined above.

### BRIEF DESCRIPTION OF THE DRAWINGS

Further advantages and features will become more clearly apparent from the description below of one embodiment of a floating vessel or of a rolling and/or sliding land vehicle and of one mode of execution of a method for operating a pulling device, and from the attached drawings, in which:

FIG. 1 is a partial schematic view of a floating vessel according to one embodiment.

FIG. 2 is a schematic view of a rolling and/or sliding land vehicle according to one embodiment.

FIG. 3 is a schematic view of a pulling device of a floating vessel or of a rolling and/or sliding land vehicle according to one embodiment.

FIG. 4 is a perspective view of a plate of the pulling device according to one embodiment.

FIG. 5 is a front view of a mast of the pulling device according to one embodiment.

FIG. 6 is a detail view of the mast according to the embodiment.

FIG. 7 is a detail perspective view of a base of the mast according to one embodiment.

FIG. 8 is a partial perspective view of the pulling device according to the embodiment.

FIG. 9 is a top view of an open housing of a pulling device according to one embodiment.

### DETAILED DESCRIPTION OF PARTICULAR EMBODIMENTS

The direction in which a floating vessel moves in a straight line, in a plane parallel to the water level of a body of water, is defined as being the longitudinal direction. By convention, the direction perpendicular to the longitudinal direction, situated in a plane parallel to the water level of a body of water, is termed transverse direction. The third direction, perpendicular to the two other directions, is termed vertical direction.

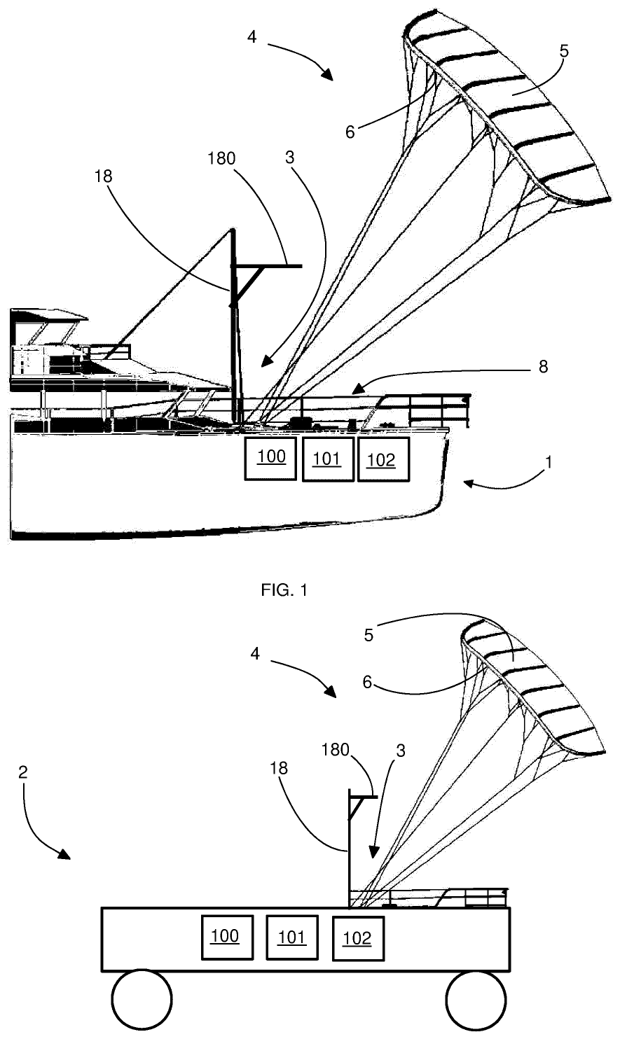

FIG. 1 schematically illustrates a floating vessel 1. Such a floating vessel 1 is, for example, a boat or a ship.

FIG. 2 schematically illustrates a rolling and/or sliding land vehicle 2. Such a vehicle is, for example, a vehicle intended to be used on a stretch of frozen water and/or on sand and/or on snow and/or on grass and/or on the ground.

The floating vessel 1, or the rolling and/or sliding land vehicle 2, comprises a pulling device 3.

The pulling device 3 comprises a kite 4. The kite 4 comprises, or includes, a sail 5. The sail 5 is provided with a leading edge 6 or comprises a leading edge 6.

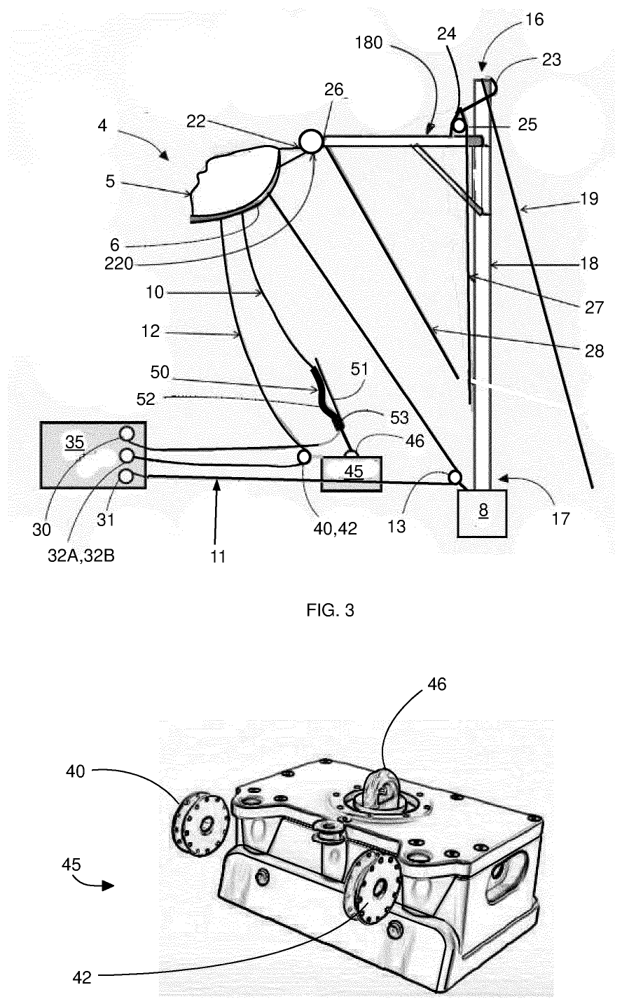

As illustrated in FIG. 3, the kite 4 comprises a flying line 11. Preferably, the flying line 11 is a central line for getting the sail to take off, retrieving the sail and, if necessary, securing the sail. The kite 4 also comprises at least one front line 10. Preferably, the kite 4 comprises two front lines 10. The kite 4 also comprises at least one rear line 12. Preferably, the kite 4 comprises two rear lines 12.

As an alternative, the kite 4 comprises at least three front lines 10 and at least three rear lines 12.

The at least one front line 10 comprises or is equipped with a clutch 50. The clutch 50 is, for example, a model sold under the trademark CONSTRICTOR by COUSIN TRESTEC. The clutch 50 comprises a sock 52 or a tube made of braided material that surrounds the front line 10. The clutch 50 also comprises a control 51, of the cord type for example. A pull on the cord 51 releases the clutch, that is to say unlocks the front line comprising this clutch. The clutch 50 also comprises a fastener 53 intended to be fastened to a fixed, or at least temporarily fixed, point of the floating vessel or of the land vehicle. As an alternative, the clutch 50 is of the cam and/or pinching and/or bracing type. The clutch is fastened to a ring 46 mounted on a plate 45 fastened to the vessel or the vehicle, as illustrated in FIGS. 3, 4 and 8.

Advantageously, the floating vessel 1 comprises a deck 8 and a mast 18 arranged on the deck 8.

Advantageously, the rolling and/or sliding land vehicle 2 comprises a chassis and a mast 18. For example, the mast 18 is arranged on the chassis, preferably at the front of the land vehicle.

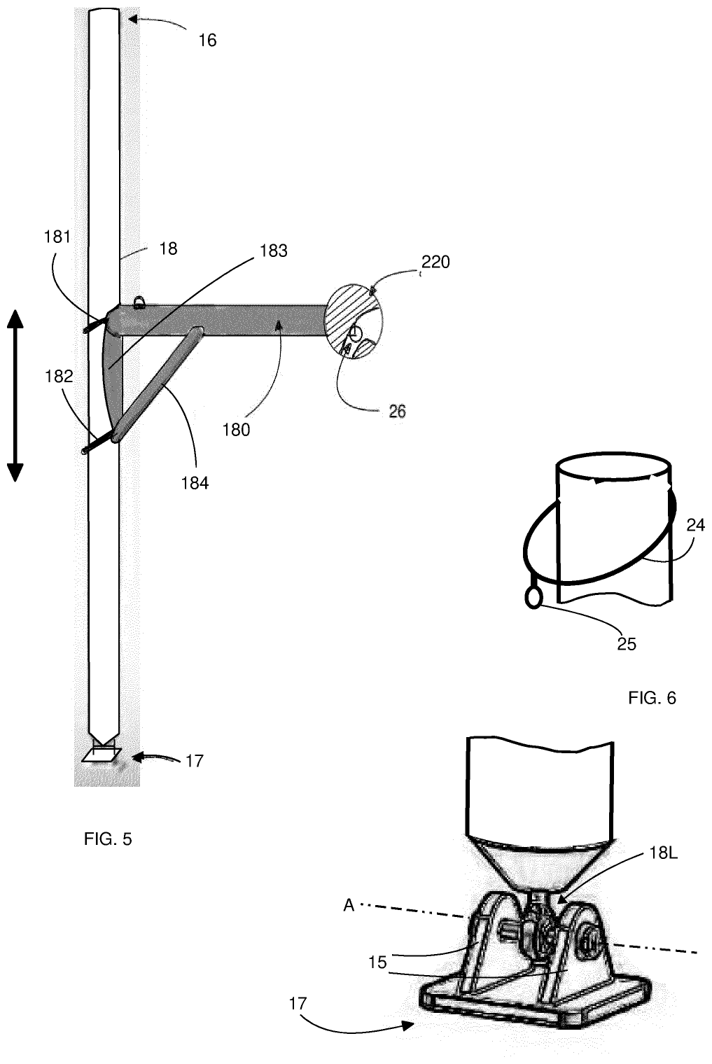

As illustrated in FIG. 3, preferably, at least one stay 19 ensures the holding of the mast 18 and/or makes it possible to orient the mast 18 with respect to a base 17 supporting the mast. Preferably, as illustrated in FIGS. 5 and 7 in particular, the base 17 comprises a connection of the ball joint type, or substantially of the ball joint type, with respect to the mast 18. For example, the base 17 comprises a yoke 15 having a pivot axis A and the mast comprises an end 18L, on the side of the base 17, of the ball joint link type. The base 17 is advantageously fastened to the deck 8 of the floating vessel 1 or to the chassis of the rolling and/or sliding land vehicle 2. Advantageously, as illustrated in FIGS. 1, 2, 3 and 5, the mast 18 comprises a boom 180. The boom 180 is pivotable around the mast 18, that is to say is orientable. Preferably, as illustrated in FIG. 5, the beam 180 may also slide along the mast 18, notably by virtue of a retaining means surrounding the section of the mast. Such a retaining means comprises, for example, an upper link 181 and a lower link 182. Preferably, the boom 180 comprises a support 183 and a reinforcement 184. For example, the reinforcement 184 extends obliquely between the support 183 and the boom 180.

As illustrated notably in FIGS. 3 and 6, the top 16 of the mast 18 comprises a sliding means 25 for a link, notably a link of the halyard 27 type. The halyard 27 makes it possible to hoist the orientable boom 180 along the mast 18. It should be noted that the boom 180 holds the sail 5 by way of a disconnecting means 26. The pivoting of the boom 180 with respect to the mast 18 allows it to follow the wind in the manner of a wind vane facing the wind. The sliding means 25 is, for example, a pulley. Preferably, a fastening means 24 ensures the holding of the pulley 25 with respect to the top 16 of the mast 18. The fastening means 24 is, for example, a ring of sufficiently large diameter for being arranged around the section of the mast. Advantageously, the ring 24 is held on the mast by a fastening means, for example a hook 23 (FIG. 3), so as to allow several degrees of freedom between the ring 24 and the mast 18. Advantageously, that end of the boom 180 which is arranged on the side of the sail 5 and/or the disconnecting means 26 comprise a damping means so as to protect the leading edge 6 in the event of movements of the kite 4 toward this end. Advantageously, the damping or protection or shock-absorbing means 220 is made of flexible materials. For example, the damping means envelops the disconnecting means 26. As an alternative, the damping means is interposed between the sail and the disconnecting means. For example, the damping means is inflatable.

In summary, the orientable boom 180 (which is potentially length-adjustable) is hoisted up the mast 18 with the aid of the halyard 27. The boom 180 holds the sail 5 at its flight angle of attack by way of the flying line 11. The rotation or pivoting of the boom 180 around the mast 18 makes it possible to always keep the sail 5 facing the wind and at a good flight angle of attack regardless of variations in the direction of the relative wind.

For example, the disconnecting means 26 is of the releasable snap hook type between the boom 180 and the sail 5. For example, a pendant 22 is arranged between the sail 5 and the disconnecting means 26. Also advantageously, a control means 28 for the disconnection of the disconnecting means 26 is provided. The control means 28 is, for example, of the messenger type, that is to say a flexible rope or link making it possible to pull on the releasable snap hook 26 remotely so as to disconnect the boom 180 from the sail 5, via the disconnection with the pendant 22.

Thus, during the hoisting of the sail 5 along the mast 18 by way of the boom 180 that is free to rotate about the axis of the mast, the sail 5 naturally orients itself into the wind. This results in flight stability of the sail 5 held in captive flight between the snap hook 26 and the flying line 11. In the event of residual relative movements or shocks or contact between the leading edge 6 and the orientable boom 180, they are advantageously damped by the shock absorber 220.

The pulling device 3 also comprises a housing 35 comprising actuators, for example of the geared motor or winch or electric winch type 30, 31, 32A, 32B. The housing 35 is advantageously fastened to the deck 8 of the floating vessel 1 or the chassis of the rolling and/or sliding land vehicle 2. Potentially, the housing 35 is movable between at least two separate positions. For example, the housing 35 via which the tensile forces of the sail 5 pass is disposed at an optimal location according to the configuration of the pulled floating vessel or of the pulled land vehicle. Thus, for example, the housing 35 is positioned differently according to the configuration of the floating vessel, for example in terms of volume and/or weight of cargo, where appropriate, and/or for example in terms of location of the cargo.

Preferably, as illustrated in FIG. 9, the housing 35 comprises four geared motors. Each geared motor comprises, or drives in rotation, a means for winding in/unwinding at least one line. Preferably, the winding in/unwinding means is of the drum type. Thus, preferably, the geared motor 30 comprises a drum 60 and/or the geared motor 31 comprises a drum 61 and/or the geared motor 32A comprises a drum 62A and/or the geared motor 32B comprises a drum 62B. More specifically, the geared motor 32A serves to control a rear line, in particular by winding it in or unwinding it. Preferably, another geared motor 32B serves to control another rear line, in particular by winding it in or unwinding it. It should be recalled that the actions (winding in or unwinding) on the rear lines make it possible to control the sail 5. Thus, the actuation in rotation of the geared motor 32A, in a direction for winding in, or in the opposite direction for unwinding, the corresponding rear line, makes it possible to act on the sail 5 without any human action on the rear line in question. The actuation in rotation of the other geared motor 32B, in a direction for winding in, or in the opposite direction for unwinding, the other rear line, makes it possible to act on the sail 5 without any human action on the other rear line. Each geared motor may be actuated in one direction of rotation or in the opposite direction of rotation independently of the other geared motor.

Advantageously, in order to limit the energy consumption required for the operation of each geared motor, a connection, notably a mechanical or hydraulic connection, is provided between the geared motors 32A, 32B. For example, the connection is activated when the geared motors operate in opposite directions of rotation.

Furthermore, a geared motor 30 serves to control the front lines 10 simultaneously or substantially simultaneously, in particular by winding them in or unwinding them. In the event of two front lines 10, the two lines are actuated together, that is to say simultaneously. Thus, the actuation in rotation of the geared motor 30, in a direction for winding in, or in the opposite direction for unwinding, the front lines, makes it possible to act on the sail 5 without any human action on the front lines. Lastly, a geared motor 31 serves to control the flying line 11, in particular by winding it in or unwinding it. Thus, the actuation in rotation of the geared motor 31, in a direction for winding in, or in the opposite direction for unwinding, the flying line, makes it possible to deal with the take-off, the retrieval and the securing of the sail 5 without any human action on the flying line 11.

As illustrated in FIGS. 3, 4 and 8, the pulling device 3 also comprises the plate 45. The plate 45 is preferably fixed with respect to the deck 8 of the vessel 1 or the chassis of the vehicle 2. The plate 45 is equipped with passage means 40, 42 for lines, for example of the pulley or diabolo type or even of the fixed deflection type with a low friction coefficient. The plate 45 makes it possible to arrange the lines between the geared motors substantially parallel to the deck 8 of the floating vessel. In other words, the plate 45 makes it possible to offset the parts of the lines extending in the direction of the sail 5 at a distance from the housing 35, notably such that the lines do not interfere with the housing 35. A holding means 13 for holding the flying line 11 in the vicinity of the mast, for example of the pulley or diabolo type or an element intended to allow sliding with little friction, is provided.

Preferably, the plate 45 comprises electronic tension sensors required for the control and/or at least one inertial unit, and/or electronic tension sensors and/or at least one inertial unit are arranged in specific and strategic areas in the vicinity of the plate 45.

As an alternative, the plate 45 is movable with respect to the deck 8 or the chassis, in particular in order to maximize the performance.

As illustrated in FIGS. 1 and 2, the floating vessel or the land vehicle comprises a computer program product 100 comprising program code instructions recorded on a computer-readable medium, and/or a computer-readable data recording medium 101, and/or a signal 102 of a data medium.

The pulling device also comprises all the hardware and/or software elements that make it possible to implement the method that forms the subject of the invention, notably hardware and/or software elements designed to implement the method that is the subject of the invention, and/or the device comprises means for implementing the method that is the subject of the invention as described below.

A mode of execution of an operating method will now be described. This method is advantageously a method for automatically operating the pulling device as described above.

Preferably, in a first step, the leading edge 6 of the sail 5 is inflated. To this end, for example, the sail 5 is turned into the wind. In an alternative, the sail is inflated with compressed air.

A step of making the sail 5 gain altitude is carried out. During this step of gaining altitude, the sail 5 is held only by the flying line 11. More specifically, the geared motor 31 unwinds the flying line 11 by driving the drum 61 in the unwinding direction. As illustrated in FIG. 3, the flying line 11 is kept taut during the step of gaining altitude. In this step of gaining altitude, the front line or lines 10 and the rear line or lines 12 remain slack. It should be noted that this gain in altitude is possible and facilitated by the sail 5 which positions itself, orients itself, with low drag so as to fly without pulling, or substantially without pulling. Specifically, when the sail is held by the single flying line, it positions itself in a stable-flight configuration, placing little stress on the flying line.

For example, the step of gaining altitude comprises a step of hoisting the sail 5 along the mast 18 (FIG. 3 in particular). It should be recalled that a pendant 22 fastened for example at the leading edge 6 of the sail 5 is connected, by way of the releasable fastener 26, to the halyard 27. Thus, as the flying line 11 is lengthened while keeping it taut, the halyard 27 is shortened. Specifically, it should be recalled that the halyard 27 cooperates with the pulley 25 held with respect to the top of the mast by the fastening means 24. Thus, as the sail 5 begins to climb, the halyard 27 is about two times the height of the mast (if the pulley 25 is arranged at the top of the mast). Advantageously, the pulley 25 is arranged at a distance from the top 16 of the mast 18 so as to prevent the fastening means 24 and/or the leading edge 6 from passing over the top 16, or even getting stuck during the launch step, subsequent to turbulence or to movements of the vessel 1 or of the vehicle 2.

In order to gain altitude, only the flying line 11 is unwound gradually while being kept taut, via the geared motor 31. It should be recalled that the front and rear lines remain slack.

In the event of a gain in altitude along the mast 18, a step of freeing the sail 5 with respect to the mast 18 is then carried out. Preferably, the sail 5 is at the top 16, or substantially at the top 16. To realize this freeing, the releasable fastener 26 is actuated, for example by pulling on the messenger 28 (connected to the snap hook 26), thus opening the snap hook 26 when necessary. This has the result that the sail 5 is disconnected from the mast. Advantageously, it is possible to continue to make the sail 5 freed from the mast gain altitude by unwinding of the flying line 11 while keeping it taut, the sail 5 remaining in flight.

Once the altitude has been reached, for example once a predetermined target altitude has been reached, a step of locking the front line 10 is carried out. This locking of the front line 10 is preferably carried out by activation of the clutch 50. It should be recalled that the activation of the clutch 50 makes it possible to mechanically connect the front line 10 provided with the clutch 50 to the floating vessel 1 or to the rolling and/or sliding land vehicle 2, for example to the deck 8 of the floating vessel or to the chassis of the land vehicle 2 via the plate 45. To this end, the front line 10 is locked in the fastener 53. Preferably simultaneously or substantially simultaneously, a step of releasing the flying line 11 and keeping it slack is carried out such that the flying line no longer has an effect on the sail of the kite. In other words, in order to eliminate the tension on the flying line 11, the geared motor 31 is actuated, for example over a given angular portion, in the unwinding direction. Most of the forces being applied to the sail are reacted on the plate 45 via the front line and the clutch. This makes it possible to pull the vessel or the land vehicle. The clutch makes it possible to not stress the geared motor enabling the winding in of the front line.

Simultaneously with, or after the locking step, a step of tensioning the rear lines 12 is carried out. This tensioning step is performed by the geared motors 32A, 32B which are actuated so as to wind in the rear lines 12 on the drums 62A, 62B, for example over a given angular portion. Once the rear lines 12 have been tensioned, the rear lines are used to control the sail 5. In other words, the geared motors 32A, 32B are used to control the sail 5 via winding-in and/or unwinding operations of the drums 62A, 62B, while maintaining the rear lines with a certain degree of tension such that they are not slack. Advantageously, the geared motor 30 is used to wind in/unwind the front lines, while maintaining them with a certain degree of tension such that they are not slack. Unlike the flight during the phase of gaining altitude in which only the flying line 11 is taut and the drag is substantially zero, the use of the front and rear lines makes it possible to control the sail 5 and to obtain the desired tensile forces.

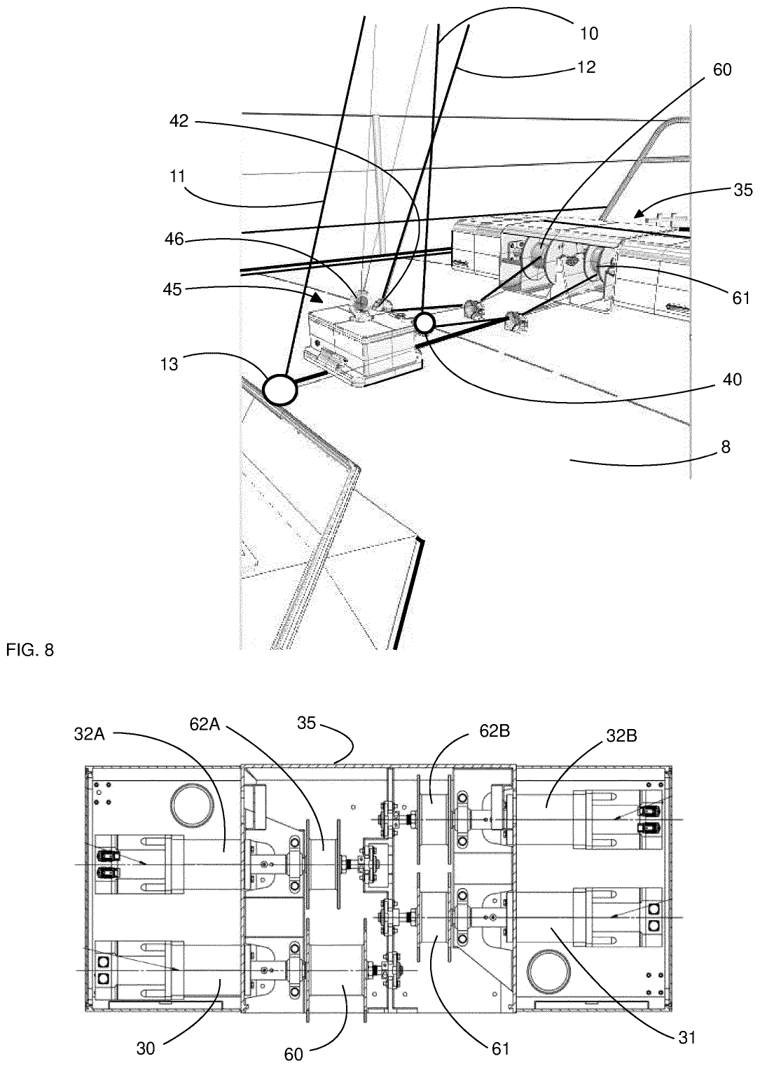

The rear lines 12 are then controlled to control the sail 5 in a flight mode of the sail 5. To this end, as illustrated in FIGS. 3 and 8, the front and rear lines 10, 12 extend into the housing 35. As mentioned, the geared motor or motors 30, 31, 32A, 32B of the control device make it possible to wind in or unwind the lines, potentially simultaneously. Thus, the type of flight is controlled depending on what is most appropriate in terms of navigation for the floating vessel or the land vehicle.

After the flight of the kite sail, in particular for pulling of the floating vessel 1 or of the land vehicle 2, the sail of the kite is retrieved. Firstly, a step of tensioning the flying line 11 is carried out. The geared motor 31 of the box 35 causes a rotation of the drum 61 so as to wind in the flying line automatically, notably until it is tensioned. Simultaneously, a step of releasing the front and rear lines 10, 12 and keeping them slack is carried out. This step of releasing and keeping slack is performed by unwinding the front and rear lines 10, 12 by way of the geared motors 30, 32A, 32B of the box 35. It should be noted that, in order to release the front line 10, it suffices to pull on the cord 51 for releasing the clutch 50, this having the effect of allowing the front line to slide with respect to the fastener 53. Secondly, the flying line 11 is wound in by way of the geared motor 31 which makes it possible to wind in the line 11 on the drum 61. It should be recalled that the flying line 11 rubs or slides or cooperates with the pulley 13. Thus, as the flying line 11 is wound in, the sail moves closer to the pulley 13 (FIGS. 3 and 8). Since the pulley 13 is preferably arranged in the vicinity of the foot of the mast 18, the winding in of the flying line brings the sail 5 back to the floating vessel 1 or to the rolling and/or sliding land vehicle 2.

The invention also relates to the use of a clutch 50 of the type forming a braided sleeve surrounding a line, notably a front line, for holding a sail 5 of a kite 4 for pulling of the vessel or of the land vehicle. This use is for example carried out in the context of the operating method described above.

It should be recalled that the pulling device 3 is preferably intended to pull a floating vessel 1, or to move a rolling and/or sliding land vehicle 2.

It should be noted that the solution therefore achieves the desired objective of providing a method for operating a kite-based pulling device, in particular intended to pull a floating vessel, improving the take-off, the flight and the retrieval of the kite, and has the following advantages:
it is economical;
it is easy to install on a vessel or a land vehicle.

1. A method for operating a pulling device of a floating vessel or of a rolling and/or sliding land vehicle, comprising a kite including:
a sail provided with a leading edge,
a flying line,
at least one front line equipped with a clutch, and
rear lines,
the method comprising:
making the sail gain altitude, holding the sail only by the flying line, the at least one front line and the rear lines remaining slack, followed, once an altitude has been reached by
locking the at least one front line by activation of the clutch to mechanically connect the at least one front line to the floating vessel or to the rolling and/or sliding land vehicle, and releasing the flying line and keeping the flying line slack.

2. The method as claimed in claim 1, wherein the method comprises, simultaneously with or after the locking, tensioning the rear lines so as to use the rear lines to control the sail.

3. The method as claimed in claim 1, wherein the method comprises, before making the sail gain altitude, inflating the leading edge of the sail.

4. The method as claimed in claim 1, wherein making the sail gain altitude comprises hoisting the sail along a mast of the floating vessel or of the rolling and/or sliding land vehicle.

5. The method as claimed in claim 4, wherein the method comprises automatically orienting the sail with respect to the wind.

6. The method as claimed in claim 4, wherein making the sail gain altitude comprises freeing the sail with respect to the mast, then making the sail freed from the mast gain altitude.

7. The method as claimed in claim 1, wherein the locking is followed by controlling the rear lines in order to control the sail in a flight mode of the sail.

8. The method as claimed in claim 7, wherein, subsequent to the controlling, the following is carried out:
tensioning the flying line, and
releasing the at least one front line and the rear lines and keeping them slack.

9. The method as claimed in claim 8, wherein the flying line is wound in so as to bring the sail back onto the floating vessel or onto the rolling and/or sliding land vehicle.

10. A pulling device of a floating vessel or of a rolling and/or sliding land vehicle, comprising:
a set of actuators,
hardware and/or software elements designed to implement the method as claimed in claim 1.

11. A floating vessel or rolling and/or sliding land vehicle, comprising the pulling device (3) as claimed in claim 10.

12. A computer program product comprising program code instructions recorded on a computer-readable medium that, when the program is executed by a computer, lead the computer to control implementation of the method as claimed in claim 1.

13. A computer-readable data recording medium on which a computer program comprising program code instructions for implementing the method as claimed in claim 1 is recorded.

14. pulling device of a floating vessel or of a rolling and/or sliding land vehicle, carrying the computer program product as claimed in claim 12.

15. The method as claimed in claim 1, comprising using a clutch forming a braided sleeve surrounding the line for holding the sail.

16. The method as claimed in claim 1, wherein making the sail gain altitude is carried out until a target altitude has been reached.

17. The method as claimed in claim 3, wherein the method comprises, before making the sail gain altitude, inflating the leading edge of the sail by turning the sail into the wind.

18. The method as claimed in claim 5, wherein the method comprises automatically orienting the sail with respect to the wind by way of a boom articulated with respect to the mast.

19. The method as claimed in claim 7, wherein the locking, the tensioning and the releasing and keeping slack, are followed by the controlling of the rear lines in order to control the sail in the flight mode of the sail.

20. The method as claimed in claim 19, wherein the controlling of the rear lines in order to control the sail in the flight mode of the sail is carried out by way of at least one geared motor of a control device.
